(19) United States
(12) Patent Application Publication
(10) Pub. No.: US 2014/0372180 A1
(43) Pub. Date: Dec. 18, 2014

(54) MERCHANT DEMOGRAPHIC ESTIMATION METHODOLOGY

(71) Applicant: MASTERCARD INTERNATIONAL INCORPORATED, Purchase, NY (US)

(72) Inventors: Bruce W. MacNair, Stamford, CT (US); David Grossman, Brooklyn, NY (US); Henry Weinberger, New York, NY (US)

(21) Appl. No.: 14/306,980

(22) Filed: Jun. 17, 2014

Related U.S. Application Data
(60) Provisional application No. 61/836,144, filed on Jun. 17, 2013.

(51) Int. Cl. G06Q 30/02

(52) U.S. Cl. CPC G06Q 30/0205
USPC 705/7.34

(57) ABSTRACT

A system, a method, and a computer program product provide competitive data to a subscribing merchant regarding customers of the subscribing merchant and competing peer merchants. A computing device loads at least one microsegment hold table. The microsegment hold table is previously generated from demographic attributes regarding a plurality of individuals. The computing device identifies hashed recognition IDs associated with payment transactions completed at the subscribing merchant and competing peer merchants. The microsegment hold table and identified hashed recognition IDs are merged to generate a microsegment summary file. The microsegment summary file is transferred. The microsegment summary file and a microsegment definition file are merged to create a summary file indicating a number of identified recognition IDs associated with various statistics. The computing device is then utilized to summarize the various statistics according to microsegment demographic attributes and breaks to generate summarized demographics.

This application claims the benefit of provisional patent application No. 61/836,144 filed on Jun. 17, 2013.

### CROSS-REFERENCE TO RELATED APPLICATIONS

This application is related to application Ser. No. 13/437,987 (published as U.S. Patent Application Publication 2013/0024242 A1, “Protecting Privacy in Audience Creation” (“Villars et al.”)). The subject matter of Villars et al. is incorporated by reference herein in its entirety.

### FIELD OF THE DISCLOSURE

The present disclosure relates to competitive data analysis and reporting, particularly in the field of merchant demographics. More specifically, disclosed are a system, a method, and a computer program product allowing a subscribing merchant to register and obtain information about demographic characteristics of both the subscribing merchant's own customers and about the demographic characteristics of customers of a group of competing peer merchants. This information is regarding a certain geographic region and delivered to a viewing environment allowing access by the subscribing merchant such as via demographic reports. The information may be obtained in a periodic fashion (i.e. on a weekly basis, a bi-weekly basis, a monthly basis, etc.). The resulting demographic reports contain summarized transaction data only and therefore do not disclose the identity of competing merchants or personal data of customers.

### BACKGROUND OF THE DISCLOSURE

The desire to gain information regarding a competing business is timeless and international. In seeking to best exist in a competitive marketplace, knowledge of how merchants and their competitors are performing is vital to the operation of a successful business. These can include simply walking across the street and seeing how much a competing peer merchant is charging for a product (as with Sam Walton in the early years of WalMart) or performing a complex analysis of the business of a multimillion dollar competitor.

As important part of obtaining competitive data on competing peer merchants is obtaining information on customer individuals shopping at local establishments. By obtaining demographic data on customers, on traits of customers, etc., determinations may be made regarding the products or services a customer desires to purchase, the price he or she wants to pay, the quantity of products or services desired, at what times of the year a customer desires to purchase products or services, etc., and therefore the subscribing merchant is best able to compete in the competitive marketplace by offering the most desirable products or services.

With this background, note that credit card companies (better referred to presently as “payment instrument” issuing institutions, thanks to the issuance of a variety of new technologies for making payments including not only credit cards, debit cards, electronic wallets, transponder devices, near-field communication enabled (“NFC”) smartphones, or similar presently existing or after-arising technology) are capable of mining extraordinary amounts of data from transactions processed electronically through payment instrument networks.

Data obtained from every transaction includes the amount the transaction is for, whether the transaction is approved or disapproved, the time the transaction was approved, and numerous other data points. Accordingly, there is a need for a method, system, and computer product which offers a subscribing merchant the ability to obtain data from their own establishment as well as data from a plurality of competing peer merchants on the demographics of all customer individuals, while not directly disclosing confidential information regarding the customers themselves.

### SUMMARY OF THE DISCLOSURE

The present disclosure provides a method, a system, and a computer program product for summarizing a plurality of statistics regarding customers of a subscribing merchant and competing peer merchants and making these statistics available to the subscribing merchant such as via at least one demographic report or by other means in a viewing environment. Since multiple anonymizing steps are performed across a variety of computing environments and the statistics are delivered in an anonymous fashion, no one individual customer may be identified by the subscribing merchant. The identity and other personal information regarding the customers themselves remain anonymized to the subscribing merchant while still allowing the subscribing merchant to obtain competitive data. In an embodiment, when delivering the plurality of statistics to the subscribing merchant, zip code, zip code and surrounding zip codes, or other geographic area are relied upon in delivering the plurality of statistics.

In accordance with a first aspect of the present disclosure, during execution of the presently disclosed method, system, and computer program product a computing device loads at least one previously generated microsegment hold table into a database without personally identifiable information. The previously generated microsegment hold table loaded may be generated as further described herein, or by any other means. The computing device identifies hashed recognition IDs associated with completed payment transactions completed at a subscribing merchant or competing peer merchants over a timeframe. In an embodiment of the presently disclosed system, method, and computer program product, the computing device only identifies hashed recognition IDs associated with completed payment transactions completed within a certain geographic area where the subscribing merchant is located, such as a zip code, the zip code and surrounding zip codes, county, state, country, etc. The timeframe may be one year, six months, one month, two weeks, one week, five days, three days, and one day, or any other timeframe. The at least one previously generated microsegment hold table and identified hashed recognition IDs are merged to generate a microsegment summary file. The microsegment summary file is transferred to a limited-access computing environment. The limited-access computing environment may be maintained by a financial transaction processing agency. In alternate embodiments, any limited-access computing environment is utilized. The microsegment summary file and a microsegment definition file are merged to create a summary file indicating a number of identified recognition IDs associated with various statistics. The computing device summarizes a plurality of statistics according to microsegment demographic attributes and breaks to generate summarized demographics. In an embodiment, the step of summarizing the plurality of statistics according to microsegment demographic attributes and breaks to generate summarized demographics further comprises adjusting the summarized demographics via application of adjustment factors. The summarized demographics may be transferred to a viewing environment to allow access by the subscribing merchant and/or made available to view via at least one demographic report.

In accordance with a second aspect of the present disclosure, during execution of the presently disclosed method, system, and computer program product a computing device generates at least one microsegment hold table. In an embodiment, the microsegment hold table is generated as follows: the computing device accesses a demographic file containing demographic attributes regarding a plurality of individuals. In an embodiment the demographic file is located in an external database. In a further embodiment, the demographic file contains at least some of the data points regarding the plurality of individuals including name of deviceholder, deviceholder identification, age of deviceholder, zip code of deviceholder, income of deviceholder, and highest educational level completed by deviceholder. The computing device generates a recognition ID for each individual whose demographic attributes are reported in the demographic file and inserts the generated recognition IDs into the demographic file. The demographic file containing the demographic attributes and recognition IDs is transferred to a limited-access computing environment, such as one maintained by a financial transaction processing agency. Microsegments are generated by summarizing demographic attributes contained in the demographic file according to a set of demographic attributes. The set of demographic attributes used for generating microsegments includes at least two of the following: zip code of deviceholder, age of deviceholder, income of deviceholder, and highest educational level completed by deviceholder. A unique microsegment sequence number is assigned to each microsegment to generate a microsegment definition file. In an embodiment, after generating the microsegments an embodiment determines whether any of the microsegments contain less than a minimum value of demographic attributes. A minimum value of demographic attributes may be 10 or in the range of 2 to 20. If less than the minimum value are found, a remediative action may be performed such as dropping the microsegment with less than the minimum value or joining the microsegment containing fewer than the minimum value with an adjoining microsegment. After performing these steps, the microsegment definition file and the demographic file are then merged to generate a crossreference file showing the microsegment sequence numbers referencing each recognition ID. The crossreference file is transferred to an external database computing environment. Each recognition ID is replaced with a generated hashed recognition ID generated by the computing device utilizing a hash function to generate at least one microsegment hold table. The at least one microsegment hold table is transferred to a database without personally identifiable information.

In accordance with a third aspect of the present disclosure, during execution of the presently disclosed method, system, and computer program product adjustment factors are applied to summarized demographics. A computing device accesses publicly available information to obtain countrywide census data and thereafter generates countrywide distribution data, according to microsegment demographic attributes and associated breaks. In an embodiment, the countrywide census data is taken from United States census data. The computing device also accesses a private universe of available deviceholder information from a private environment to generate payment instrument holder distribution data according to microsegment demographic attributes and associated breaks. The countrywide distribution data and payment instrument holder distribution data are loaded into the limited-access computing environment (such as associated with a financial transaction processing agency, etc.). Countrywide distribution data and payment instrument holder distribution data are combined with subscribing merchant distribution data and peer group distribution data into a single table according to microsegment demographic attributes and breaks. The computing device then generates a projected hashed recognition ID values for each break associated with each microsegment demographic attribute based upon countrywide distribution data, payment instrument holder distribution data, and distribution data for subscribing merchant and peer group. In an embodiment, the projected hashed proxy ID values for each break are generated according to the following formula:

$$( \begin{matrix}Subscribing Merchant or Competing Peer \\ Merchant Distribution for Break and \\ Individual Demographic Attribute\end{matrix} ) = ( \begin{matrix}Measured Number of Identified \\ Hashed Proxy IDs for Break and \\ Microsegment Demographic Attribute\end{matrix} ) * ( \begin{matrix}Number of Individual at Break \\ for Individual Demographic \\ Attribute According to Census Data\end{matrix} ) / ( \begin{matrix}Number of Individuals at Break \\ for Individual Demographic Attribute \\ According to Private Universe Data\end{matrix} ) \qquad ( Equation 1 )$$

In accordance with a fourth aspect of the present disclosure, during execution of the presently disclosed system, method, and computer program product a computing device identifies goods and/or services sold by the subscribing merchant and identifies the set of competing peer merchants selling similar goods and/or services in a geographic region. In an embodiment, the computing device identifies the geographic region by a local zip code where the subscribing merchant is located. A plurality of completed payment transactions are received completed at the set of competing peer merchants and subscribing merchant associated with a plurality of customers of the set of competing peer merchants and subscribing merchant. The computing device is utilized to flag payment transactions completed over a timeframe at the set of competing peer merchants and subscribing merchant. The timeframe may be one year, six months, one month, two weeks, one week, five days, three days, one day, or any other. A plurality of deviceholder identifications associated with a plurality of payment instruments utilized to complete each flagged payment transaction are extracted. The extracted plurality of deviceholder identifications are transferred to an anonymized processing environment. Hashed deviceholder identifications are received from the anonymized processing environment and inserting into a data file. A customer information database containing a cross-reference file is accessed to determine a plurality of demographic attributes associated with the hashed deviceholder identifications. The demographic attributes associated with the individuals holding each anonymized deviceholder identification are aggregated to generate anonymous statistical data and inserting into the data file. Anonymous statistical data are adjusted to become representative of population demographics. The population demographics used in adjusting anonymous statistical data is generated from town demographics, county demographics, state demographics, and country demographics taken from the location where the subscribing merchant is located. The adjusted anonymous statistical data is then provided to the subscribing merchant. The adjusted anonymous statistical data may be provided to the subscribing merchant in the form of a graph, a report, and a chart.

Various aspects of these embodiments may be interwoven to provide the greatest flexibility and deliver the most valuable product to the subscribing merchant. In addition to the above aspects of the present disclosure, additional aspects, objects, features, and advantages will be apparent from the embodiments presented in the following description and in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a block diagram displaying the process of completing a payment instrument transaction in an embodiment of the presently disclosed system, method, and computer program product.

FIG. 2 illustrates a flow chart displaying basic steps in generation of a demographic report to provide to a subscribing merchant in an embodiment of the presently disclosed system, method, and computer program product.

FIG. 3 illustrates a demographic report produced in an embodiment of the system, method, and computer program product.

FIG. 4 illustrates a demographic report produced in an embodiment of the system, method, and computer program product.

FIG. 5 illustrates a demographic report produced in an embodiment of the system, method, and computer program product.

FIG. 6 illustrates a flow chart displaying a process of generation of a microsegment hold table or microsegment hold tables from a demographic file in an embodiment of the system, method, and computer program product.

FIG. 7 illustrates a flow chart displaying a process of generation of demographic reports from at least one microsegment hold table in an embodiment of the system, method, and computer program product.

FIG. 8 illustrates a flow chart displaying a process of utilization of country census data and a private universe of available information to apply adjustment factors to summarized demographics in an embodiment of the system, method, and computer program product.

FIG. 9 illustrates a chart displaying results at various steps during application of adjustment factors in an embodiment of the system, method, and computer program product.

### DETAILED DESCRIPTION OF THE EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

As will be appreciated by one skilled in the art, the present disclosure may be embodied as a system, a method, or a computer program product. Accordingly, the presently disclosed system, method, and computer program product may take the form of an entirely hardware embodiment, an entirely software embodiment (including firmware, resident software, micro-code, etc.) or an embodiment combining software and hardware aspects that may generally be referred to herein as a “computing device,” “computer,” “processor,” “server,” “computing system,” “computer system,” “system,” etc. It is commonly known in the art these devices are associated with one or more processors or central processing units acting together or separately, a logic device or devices, an embedded system or systems, or any other device allowing for programming and decision making. Multiple devices or systems may also be networked together in a local-area network or via the internet to perform the same function or functions. In one embodiment, multiple processors or circuitry performing discrete tasks in communication with each other may be used. A computer, computing device, processor, server, computer system, system, etc. is a necessary element to process the large amount of data discussed in the presently disclosed system, method, and computer program product in a realistic timeframe (i.e., thousands, tens of thousands, hundreds of thousands, or more of demographic attributes associated with a similar number of individuals, and processing, report generation, etc. for this data). Furthermore, the presently disclosed system, method, and computer program product may be embodied in any tangible medium of expression having computer usable program code embodied in the medium.

Computer program code or applications for carrying out operations of the presently disclosed system, method, and computer program product may be written in any combination of any one or more programming languages, including an object-oriented programming language such as Java, Smalltalk, C++, or the like, conventional procedural programming languages, such as Visual Basic, “C,” or similar programming languages, or any other. After-arising programming languages are contemplated as well. This computer code and these computer program instructions may be provided to a processor of a computing device, computer, server, computing system, computer system, system, general purpose computer, special purpose computer, etc., or other programmable data processing apparatus to produce a machine, such that the instructions, which execute via the processor, central processing unit, etc. of the computer or other programmable data processing apparatus, create means for implementing the functions/acts specified in the flowchart and/or block diagram block or blocks. These computer programmable instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provides processes for implementing the functions/acts specified in the flowchart and/or block diagram block or blocks.

The present system, method, and computer program product described below with reference to flowchart illustrations and/or block diagrams of methods, apparatuses (systems), and computer program products according to embodiments of the presently disclosed system, method, and computer program product. It will be understood that each block of the flowchart illustrations and/or block diagrams, and combinations of blocks in the flowchart illustrations and/or block diagrams, may be implemented by the computer program instructions as discussed above.

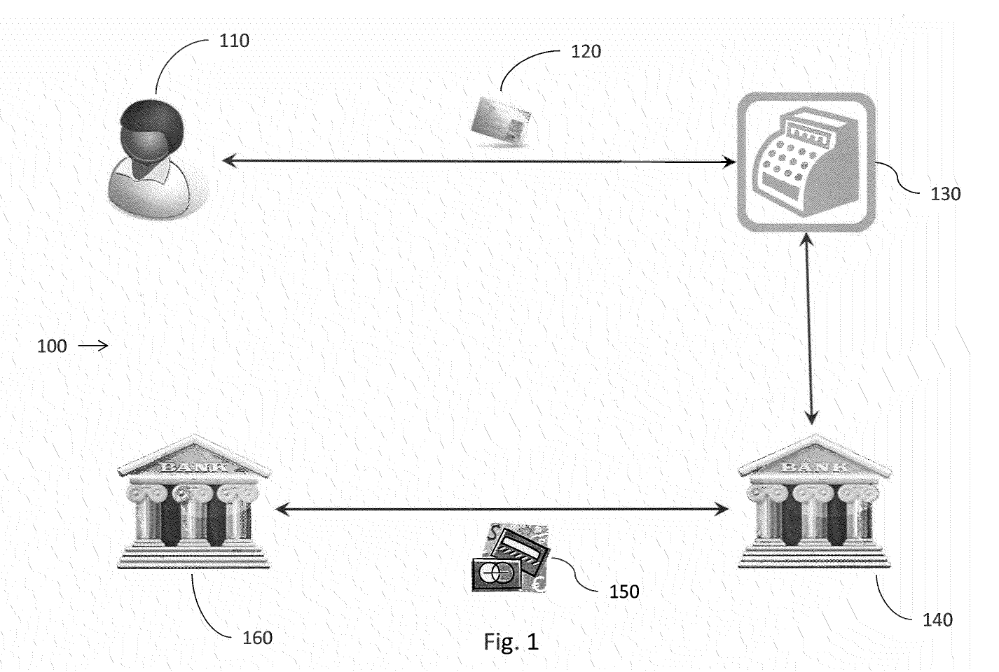

FIG. 1, illustrates a block diagram 100 generally displaying the process of completing a payment instrument transaction. An individual “customer” (also known as a “payment instrument holder” or “deviceholder”) 110 desires to purchase a good or service from a merchant 130. Customer 110 presents a payment instrument 120 (such as a credit card, debit card, electronic wallet, transponder device, NFC-enabled smart phone, or similar presently existing or after-arising technology) to the merchant 130 for payment. The merchant 130 utilizes his or her transaction acquiring device (not shown) to communicate with a merchant acquiring bank or Acquirer 140 seeking approval for this transaction. The Acquirer 140 transmits customer 110's account information (including account number and amount), seeking approval of the transaction as an authorization message formatted in accordance with ISO 8583 (which is incorporated herein its entirety) or its equivalent, to a payment instrument network 150 and a payment instrument issuing bank 160 associated with the payment instrument 120. Should approval be appropriate, the payment instrument issuing bank 160 transmits an approval message via the payment instrument network 150 to the Acquirer 140 who then retransmits the approval message to the merchant 130, who thusly learns the sale has been completed and informs the customer 110.

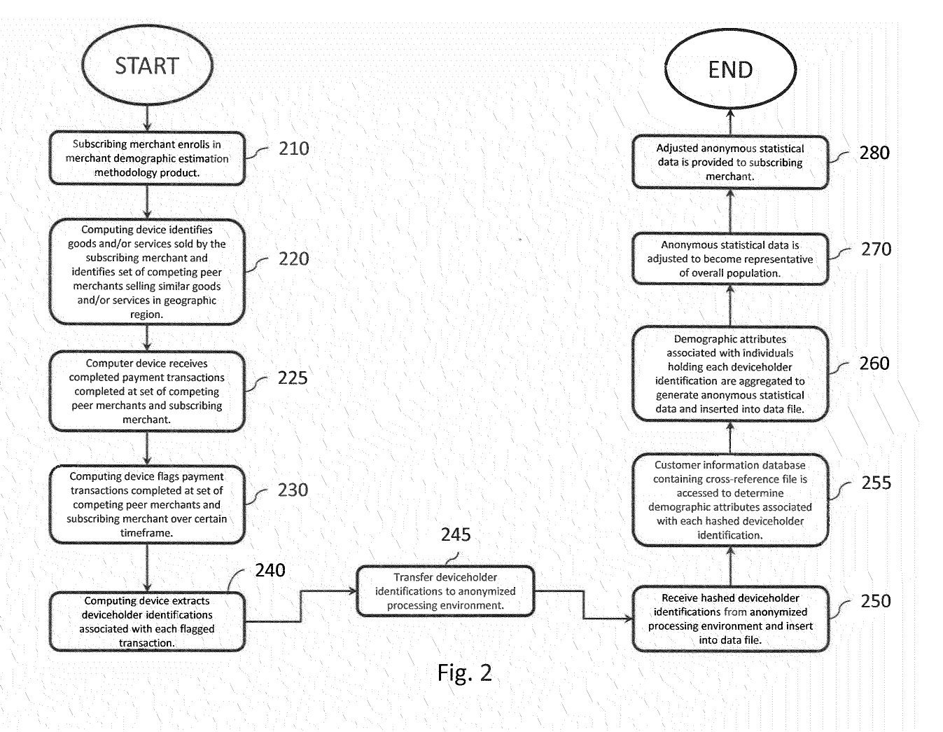

FIG. 2 illustrates a flow chart displaying basic steps in generation of a demographic report to provide to a subscribing merchant in an embodiment of the presently disclosed system, method, and computer program product. A subscribing merchant enrolls to utilize the merchant demographic estimation methodology product 210. The subscribing merchant desires to do this for many reasons, including keeping tabs on local competing merchants, to learn more about demographic attributes of potential customers of the subscribing merchant itself and competing peer merchants, to increase their own sales, etc. Regardless of the reason why, after the subscribing merchant enrolls in the merchant demographic estimation methodology product, a computing device automatically identifies goods and/or services offered by the subscribing merchant and identifies a set of competing merchants selling similar goods and/or services in a geographic region 220. The geographic region may be defined by the local zip code where the subscribing merchant is located (or the zip code and the surrounding 2-8 zip codes, etc.), the county, the state, the country, etc. The computing device receives completed payment transactions completed at the subscribing merchant and set of competing peer merchants 225. The computing device then flags payment transactions completed at the set of competing peer merchants and/or subscribing merchant over a timeframe 230. In various embodiments, the timeframe may be one year, six months, one month, two weeks, one week, five days, three days, or one day. Any specified length of time is contemplated as within the scope of the present disclosure. The computing device then extracts a deviceholder identification associated with each transaction 240. The deviceholder identification may be as simple as the credit card number associated with a completed payment transaction, or its equivalent, whether after-arising or presently-available. The deviceholder identification is then transferred into an anonymized processing environment, which restricts complete access to data 245. Hashed anonymized deviceholder identifications are received from the anonymized processing environment 250 and inserted into a data file. A customer information database containing a cross-reference file is accessed to determine demographic attributes associated with the anonymized deviceholder identification 255. The demographic attributes associated with the individuals holding each deviceholder identification are then further anonymized via aggregation of confidential statistical data for a large number of individuals utilizing this information 260, and the resulting anonymous statistical data are inserted into a data file. The anonymous statistical data obtained is then adjusted to become more representative of overall U.S. population 270. This step is performed because not every individual carries a credit card or other payment instrument, and statistics have to be adjusted to reflect this. In one embodiment, a ratio of the number of payment instrument holders in an area compared with the number of total population is utilized to correct information. In other embodiments other data points such as the number of payment instrument holders in a certain age group, ethnic group, or any other information is utilized to adjust the anonymous statistical data. At step 280, the adjusted anonymous statistical data is provided to the subscribing merchant.

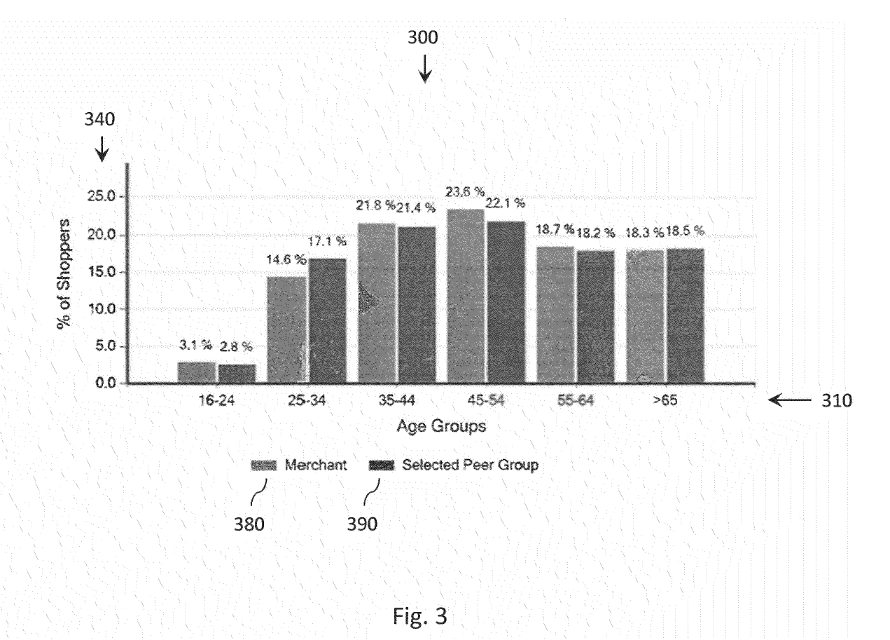

FIG. 3 illustrates a first demographic report 300 produced in an embodiment of the presently disclosed system, method, and computer program product. Such a demographic report 300 is utilized to provide competitive information such as to a subscribing merchant seeking to discover information about his or her competing peer merchants. Displayed on the x-axis 310 are a number of “breaks,” in an age of a deviceholder demographic attribute (“Age Groups”). The “breaks” on the x-axis 310 include for the age groups 16-24, 25-34, 35-44, 45-54, 55-64, and >65. Displayed on the y-axis 340 is a “% of Shoppers” attribute, ranging from “0.0[%]” to “25.0[%].” The demographic report 300 displays both data for the subscribing merchant (such data labeled as with 380), as well as data for a “selected peer group” (such data labeled as with 390). The “selected peer group” is, in an embodiment, a group of competing peer merchants, whose confidentiality is still maintained in reports created by the presently disclosed system, method, and computer program product. The first demographic report 300 may display, for example, a modeled profile of shoppers for the last three months based upon shopping at the subscribing merchant (380) as well as the selected peer group (390) of competing peer merchants in the geographic area.

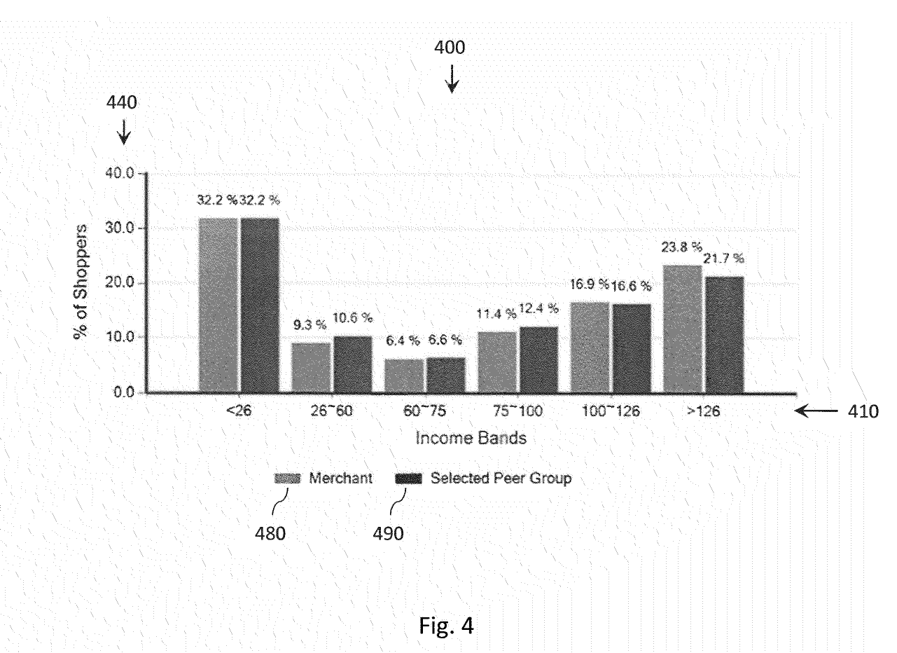

FIG. 4 illustrates a second demographic report 400 produced in an embodiment of the system, method, and computer program product. As with the first demographic report 300, the second demographic report 400 is also utilized to provide competitive information such as to a subscribing merchant seeking to discover information about his or her competing peer merchants. Displayed on x-axis 410 are a number of “breaks,” in tracked income of deviceholders' demographic attribute (“Income Bands”). The “breaks” on the x-axis 410 include for the income bands <[$]26[,000], [$]26[,000]-[$]60[,000], [$]60[,000]-[$]75[,000], [$]75[,000]-[$]100[,000], [$]100[,000]-[$]126[,000], and >[$]126[,000]. Displayed on the γ-axis 440 is a “% of Shoppers” attribute, ranging from “0.0[%]” to “40.0[%].” The second demographic report 400 displays both data for the subscribing merchant (such as data labeled as with item 480), as well as data for a “selected peer group” (such as data labeled as item 490). As previously, the “selected peer group” is, in an embodiment, a group of competing peer merchants, whose confidentiality is still maintained in reports created by the presently disclosed system, method, and computer program product. The second demographic report 400 may display, for example, a modeled profile of shoppers for the last three months based upon shopping at the subscribing merchant (480) as well as the selected peer group (490) of competing merchants.

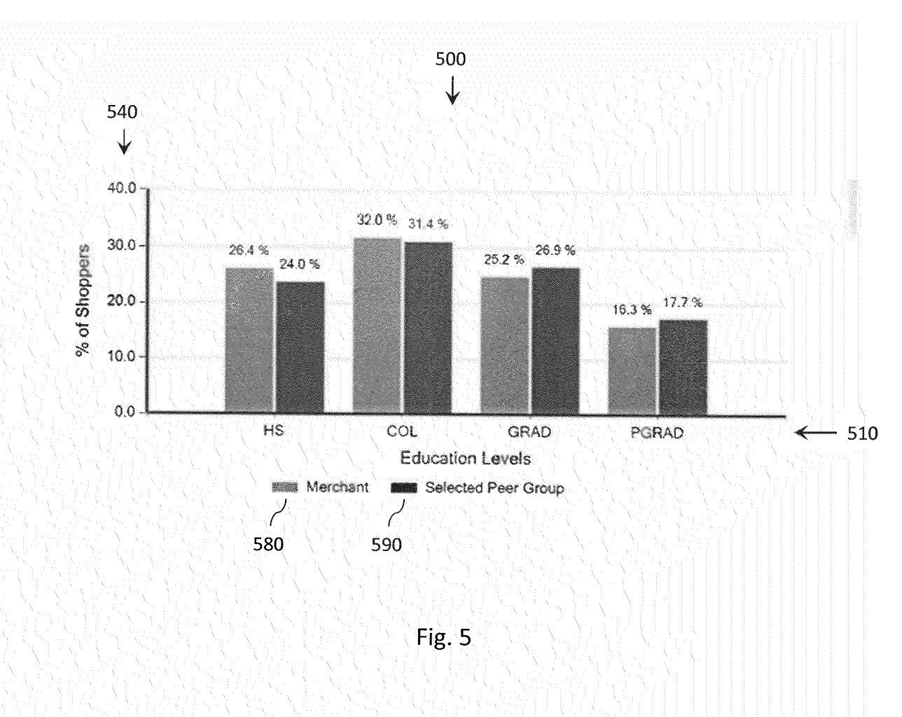

FIG. 5 illustrates a third demographic report 500 produced in an embodiment of the presently disclosed system, method, and computer program product. As with the first demographic report 300, third demographic report 500 is also utilized to provide competitive information such as to a subscribing merchant seeking to discover information about his or her competing peer merchants. Displayed on x-axis 510 are a number of “breaks,” in the highest educational level completed by deviceholder demographic attribute (“Education Levels”). The “breaks” on the x-axis 510 include for the highest educational level completed by deviceholder (e.g. high school (“HS”), college (“COL”), graduate (“GRAD”), post-graduate (“PGRAD”)). Displayed on the y-axis 540 is a “% of Shoppers” attribute, ranging from “0.0[%]” to “40.0[%].” The third demographic report 500 displays both data for the subscribing merchant (such as data labeled as with item 580), as well as data for a “selected peer group” (such as data labeled as item 590). As previously, the “selected peer group” is, in an embodiment, a group of competing peer merchants, whose confidentiality is still maintained reports created by the presently disclosed system, method, and computer program product. The demographic report 500 may display, for example, a modeled profile of shoppers for the last three months based upon shopping at the subscribing merchant (580) as well as the selected peer group (590).

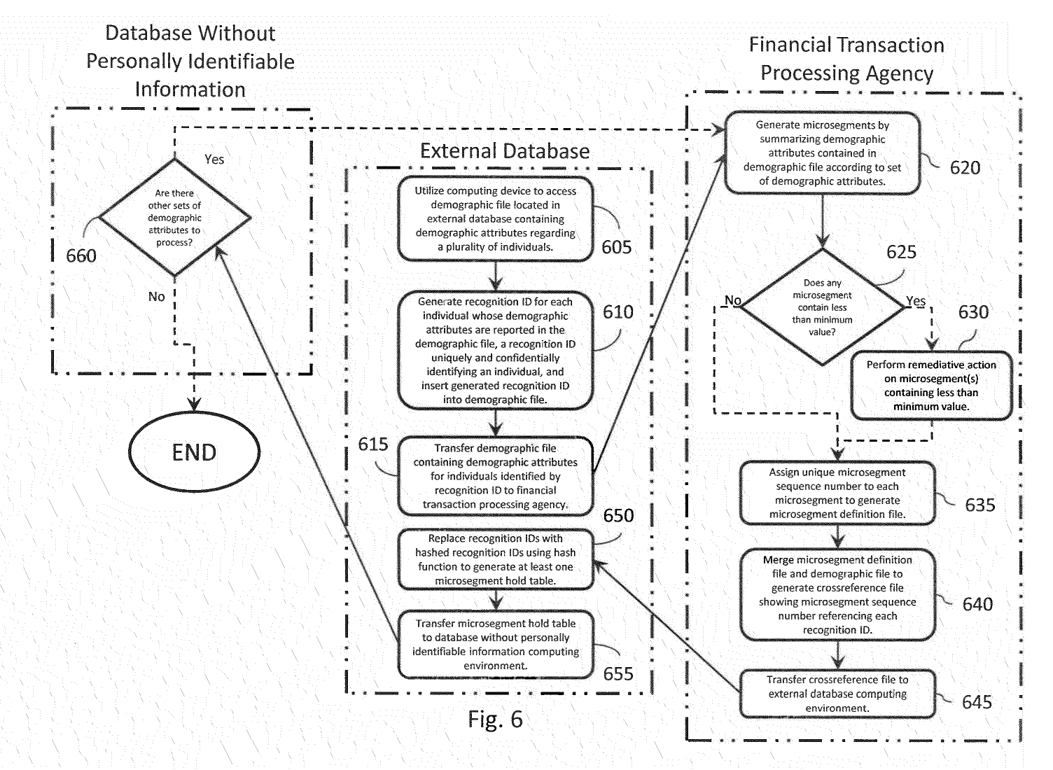

FIG. 6 illustrates a flow chart displaying a process of generation of a hold table or hold tables from demographic attributes of customers in an embodiment of the presently disclosed system, method, and computer program product. A hold table is utilized, inter alia, in the generation of demographic reports regarding a subscribing merchant's customers as well as regarding the customers of the subscribing merchant's competing peer merchants offering similar goods or services in a geographic area. In an embodiment, a hold table is generated once or twice per year, as demographic attributes regarding customers of both the subscribing merchant and competing peer merchants are updated, or a new set of demographic attributes is provided.

Execution begins in an external database at step 605. At step 605 a computing device is utilized to access a demographic file located in the external database containing demographic attributes regarding a plurality of individuals. “A demographic file,” as used herein, may refer to a computer-implemented unit of data storage storing a plurality of demographic attributes regarding a plurality of individuals including, but not limited to, a computer spreadsheet file (such as an Excel® file,), a text file, a comma-separated value file (“.csv”) file, or any other computer file allowing any sort of computer-implemented data storage. A “computer file” or “file,” as used herein generally, may also refer to any other computer-implemented storage or data structure such as a matrix, array, linked-list, tree-structure, or other presently-existing or after-arising equivalent providing computer-based data storage on a computing device. In an embodiment, the demographic file contains some or all of the following data points for a plurality of individuals: name, deviceholder identification, zip code of deviceholder, age of deviceholder, income of deviceholder, and highest educational level completed by deviceholder (e.g. high school (“HS”), college (“COL”), graduate (“GRAD”), post-graduate (“PGRAD”)). The data points zip code of deviceholder, age of deviceholder, income of deviceholder, and highest educational level completed by deviceholder qualify also as “demographic attributes,” as used herein.

At step 610 the computing device generates a recognition ID for each individual whose demographic attributes are reported in the demographic file. The recognition ID uniquely and confidentially identifies each individual. An example of a recognition ID is an encrypted name or encrypted deviceholder identification associated with an individual, or any other unique identifier identifying the individual. Utilization of recognition IDs is the first step in allowing confidential manipulation of demographic attributes associated with a plurality of individuals in the present disclosure. In an embodiment, the recognition ID for each individual is then inserted in the demographic file.

At step 615, the demographic file containing demographic attributes for individuals identified by recognition ID is transferred to a financial transaction processing agency. In an embodiment, a dedicated zone in the financial transaction processing agency is assigned for exclusive use with merchant demographic reporting and report generation.

At step 620 microsegments are generated by summarizing demographic attributes contained in the demographic file according to individual or a set of demographic attributes. In an embodiment, microsegments are generated according to a set of demographic attributes including zip code of deviceholder, age of deviceholder, income of deviceholder, and highest educational level completed by deviceholder. A “microsegment” is a representation of a group of individuals that is granular enough to be valuable to those seeking data, but still maintains a high level of consumer privacy without the use or obtaining of any personally identifiable information. Microsegments may be given to a maximum size or a minimum size. A minimum size of a microsegment may be at a minimum large enough so that no entity is personally identifiable, but small enough to provide the granularity needed in a particular circumstance. In one embodiment, a microsegment may include at least ten unique entities or have a minimum in the range of 2 to 20 unique entities. In a further embodiment, microsegments are created according to the set of demographic attributes as discussed previously, or any other set of or singular demographic attributes (collectively known herein as “microsegment demographic attributes”). Alternatively or in addition, microsegments may also be generated according to established “breaks” in demographic attributes. The “breaks” for the age of deviceholder demographic attribute may be, for example as with FIG. 3, 16-24, 25-34, 35-44, 45-54, 55-64, and >65. In such a case, for example, a microsegment will be created for the age of deviceholder demographic attribute and for all individuals aged 16-24, a microsegment for all individuals aged 25-34, a microsegment for all individuals aged 35-44, etc. Similarly, income “breaks” may be <$26,000 earned per year, $26,000-$60,000 earned per year, $60,000-$75,000, $75,000-$100,000, $100,000-$126,000, and >$126,000 (as with FIG. 4), and corresponding microsegments will be generated for these breaks. The breaks in zip code of deviceholder may be simply based upon each individual zip code, etc. More examples of breaks are included in connection with FIGS. 3-5 herein.

At step 625 a determination is made whether any of the newly generated microsegments contain less than a certain minimum value of demographic attributes or are regarding less than a minimum number of individuals. If “yes,” execution proceeds to step 630 where a remediative action is performed on the microsegment(s) containing less than the minimum value. In an embodiment, if any microsegment generated at step 620 contains fewer than ten records or is regarding fewer than 10 individuals, it will be dropped. In a further embodiment, if any microsegment generated at step 620 is regarding fewer than 10 individuals, the microsegment with less than 10 individuals is joined with an adjoining microsegment, so as to ensure complete anonymity is maintained. Alternate minimum values of demographic attributes or numbers of individuals are in the range of 2 to 20. If “no” at step 625, or after step 630, execution then proceeds to step 635.

At step 635, the microsegments (or remaining microsegments, if execution proceeded through step 630) are assigned unique microsegment sequence numbers in the course of generating a microsegment definition file. At step 640 the microsegment definition file and demographic file are merged to generate a crossreference file showing the microsegment sequence number referencing each recognition ID. At step 645 the crossreference file is transferred back to the external database computing environment. At step 650 the recognition IDs are replaced with hashed recognition IDs to generate at least one microsegment hold table (i.e., via utilization of a hash function, as that term is understood to one of ordinary skill in the art, to generate a hashed recognition ID). At step 655, the microsegment hold table is transferred to a database without personally identifiable information computing environment for further utilization.

At step 660, a determination is made whether there are other sets of demographic attributes (or “microsegment demographic attributes”) to utilize to generate microsegment hold tables. In an embodiment, the first set of microsegment hold tables generated during a first iteration of the presently disclosed method, system, and computer program product include the set of demographic attributes comprising zip code of deviceholder, age of deviceholder, income of deviceholder, and highest educational level completed by deviceholder. In an embodiment, other sets of microsegment demographic attributes are utilized in the generation of microsegments and, correspondingly, microsegment hold tables during the first or a second iteration. One example of such a set of microsegment demographic attributes includes zip code of deviceholder, age of the deviceholder, and income of the deviceholder. Any combination of microsegment demographic attributes may be utilized. With each iteration (as to step 620 et seq.), a new hold table is created. When all iterations are complete, execution proceeds to the END. The hold tables are further utilized as described herein.

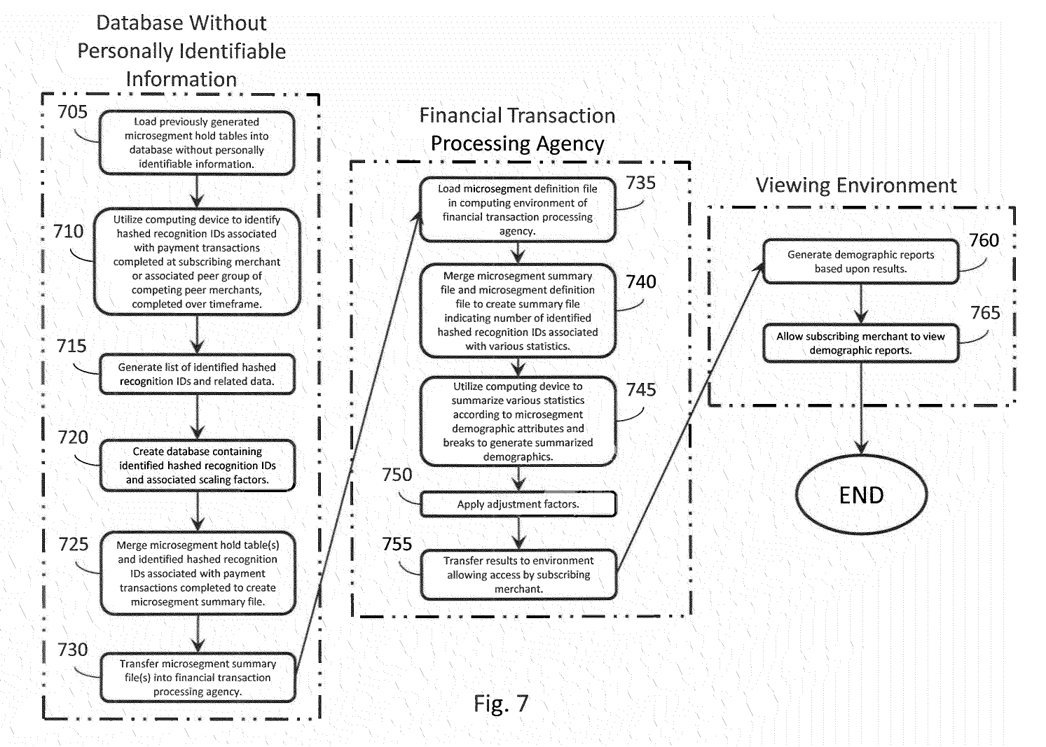

FIG. 7 illustrates a flow chart displaying a process of generation of demographic reports in an embodiment of the presently disclosed system, method, and computer program product. Execution begins in a database without personally identifiable information computing environment at step 705, where a previously generated microsegments hold table or tables are loaded into the database without personally identifiable information. The microsegment hold table or tables may have been generated such as through a process displayed in FIG. 6, or by any other means. The microsegments hold table or tables contain only hashed recognition IDs and the associated microsegment sequence number. Because the microsegments hold table(s) are generated at least once or twice annually in an embodiment, (such as discussed previously in connection with FIG. 6), if the hashed recognition IDs are contained in a microsegment hold table, the individual associated with it must have been recently-active at the subscribing merchant or competing peer merchants. Also as stated previously in connection with FIG. 6, at steps 625-630, in an embodiment, microsegments are joined or dropped if the microsegment is regarding less than a minimum value of individuals. If this check is performed at steps 625-630 during execution as described in FIG. 6, then it is known that any microsegments associated with the microsegment sequence numbers will not be regarding less than a certain number of individuals. In a further embodiment, if certain microsegment hold tables regarding certain demographic attributes are not available, other microsegment hold tables may be utilized to supplement missing data, as available. For example, therefore, a primary microsegment hold table may be regarding demographic attributes such as the zip code of deviceholder, age of deviceholder, income of deviceholder, and highest education level completed by deviceholder. If certain data is not available in the primary hold table (such as, for example, because certain microsegments are regarding less than the minimum number of individuals), a secondary microsegment hold table may also be used regarding solely the demographic attributes zip code of deviceholder, age of deviceholder, and income of deviceholder, or any combination of these and other attributes.

Execution continues to step 710. At step 710 a computing device is utilized to identify hashed recognition IDs associated with payment transactions completed at a subscribing merchant and/or at an associated peer group of competing merchants during a specified timeframe.

At step 715, in an embodiment, the computing device generates a computerized list of the identified hashed recognition IDs, as well as related data including an engagement number of the subscribing merchant seeking competitive data and demographic reports. The related data may also include a flag that is generated and set indicating whether the hashed recognition ID was active at the subscribing merchant or a member of the competing peer merchants.

Optionally, at step 720 a database is then created containing the computerized list of identified hashed recognition IDs as discussed above as well as a sum of scaling factors associated with the identified hashed recognition IDs. The database includes scaling factors for each combination of identified hashed recognition ID, engagement number, and the flag indicating where the hashed recognition ID was active. In an embodiment, scaling factors are used to adjust transaction data in order to make it more representative of overall consumer spending, and are developed quarterly based on macroeconomic and demographic sources. In a further embodiment, scaling factors are applied at a country level.

At step 725, a microsegment hold table is combined with the list of identified hashed recognition IDs associated with payment transactions completed to create a microsegment summary file. If there are multiple microsegment hold tables, the primary microsegment hold table is utilized first. In an embodiment, the microsegment summary file shows the number of identified hashed recognition IDs for each combination of engagement number of the subscribing merchant, flag indicating whether the hashed recognition ID was active at the subscribing merchant or member of the peer group, and microsegment sequence number. In a further embodiment, if after the primary microsegment hold table is utilized there are still previously identified hashed recognition IDs which are not matched with engagement number/flag/microsegment sequence number, a secondary microsegment may be utilized to create a second microsegment summary file. At step 730 the generated microsegment summary file(s) are transferred into a limited-access computing environment, such as at a financial transaction processing agency computing environment.

Execution further proceeds with step 735. At step 735 the computing device loads a microsegment definition file. The microsegment definition file may contain microsegment sequence numbers and directly or indirectly relate the microsegment sequence numbers to the summarized demographic attributes as contained in either the primary or secondary microsegment hold tables.

At step 740 the computing device merges the microsegment summary file and a microsegment definition file to create a summary file indicating a number of identified hashed recognition IDs associated with various statistics displayed by a plurality of individuals. The statistics are anonymized. In an embodiment, the summary file indicates the number of identified hashed IDs for each combination of engagement number, flag indicating whether the hashed recognition ID was active at the subscribing merchant or a member of the peer group of competing merchants; and microsegment demographic attributes. In a further embodiment, the microsegment demographic attributes are generated from the primary microsegment hold table or secondary microsegment hold table, and contains the combinations of demographic attributes tracked therein.

At step 745 the computing device is utilized to summarize various statistics according to “breaks” and microsegment demographic attributes to generate summarized demographic percentages. Microsegment demographic attributes are only summarized individually, never in a combination so as to maximize confidentiality of the data. In an embodiment, the microsegment demographic attributes (and, correspondingly, the summarized demographic percentages) include age of deviceholder, income of deviceholder, and highest education level completed of deviceholder. In a further embodiment, microsegment demographic attributes are only utilized if there are greater than ten identified hashed IDs associated with a “break” in the demographic attribute. If there are fewer than ten identified hashed IDs associated with a “break,” the demographic attributes may be combined with a neighboring “break,” or dropped entirely. This step is performed in order to maintain complete anonymity of the deviceholders.

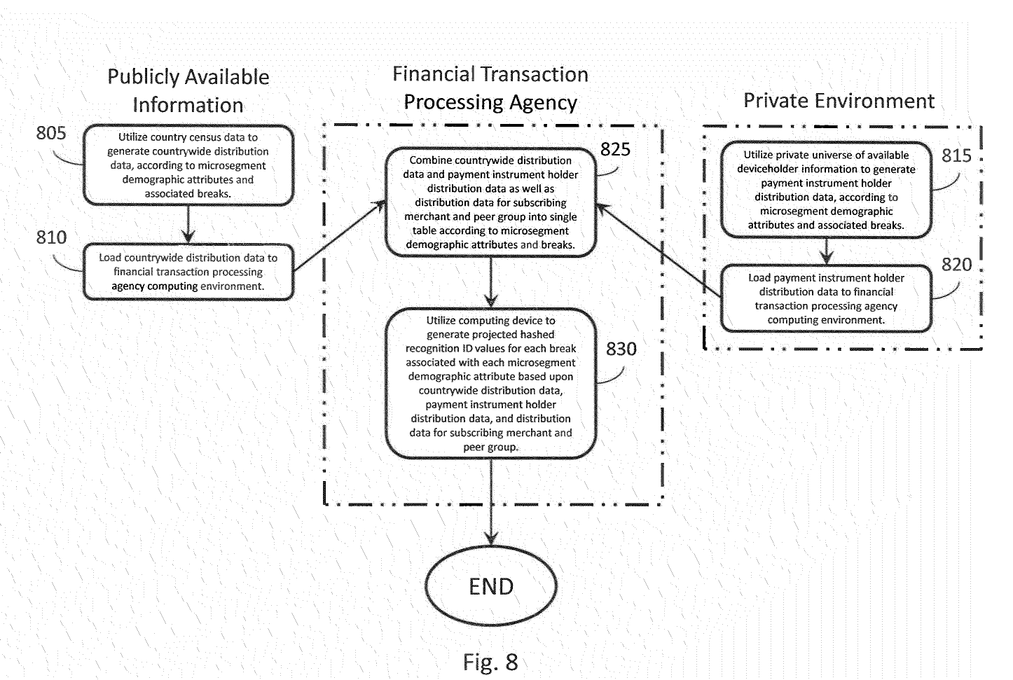

Continuing, optionally, at step 750 demographic adjustment factors are applied, as discussed further herein (see e.g. FIG. 8, below). At step 755 the results of the summary of various statistics according to microsegment demographic attributes are transferred to an environment allowing access by a subscribing merchant (a “viewing environment” computing system). At step 760 demographic reports are generated based upon the results of the summary of various statistics. At step 765 the demographic reports are made available to the subscribing merchant for viewing. In an embodiment, the demographic reports appear as the demographic reports shown in the first demographic report, second demographic report, and third demographic report, reproduced as FIGS. 3-5 herein.

FIG. 8 illustrates a flow chart indicating a process for application of adjustment factors for the adjustment of data in an embodiment of the presently disclosed method, system, and computer program product. At step 805, country census data is utilized to generate countrywide distribution data, according to microsegment demographic attributes and associated breaks. The countrywide distribution data is regarding various demographic attributes and including various “breaks,” and may be obtained for the United States, or any country. In an embodiment, the microsegment demographic attributes tracked include any combination of an age attribute, an income attribute, and a highest educational level attribute. The “breaks” may be the same as those discussed in FIGS. 3-5 herein, or any other. At step 810, the countrywide distribution data is loaded into a limited-access computing environment, such as at a financial transaction processing agency computing environment.

Steps 815-820 takes place simultaneously, before, or after steps 805-810. The precise order of execution as between these steps is insignificant. At step 815, a private universe of available information is utilized to generate payment instrument holder distribution data, according to microsegment demographic attributes and associated breaks. The microsegment demographic attributes may include any or all of the age of deviceholder, income of deviceholder, and highest educational level completed by deviceholder. Such private universe data may be tracked, for example, by a payment instrument issuing institution, an acquirer, a credit agency, or any other. At step 820 payment instrument holder distribution data is loaded into the limited-access computing environment, such as at the financial transaction processing agency computing environment.

Execution continues at step 825 at the financial transaction processing agency. At step 825 the countrywide distribution data and payment instrument holder distribution data is combined, as well as distribution data from the subscribing merchant and peer groups into a single computerized table. The computerized table is arranged according to microsegment demographic attributes and breaks, such as previously discussed. For example, the demographic attributes age, income, and highest educational level from step 805 and the demographic attributes age of deviceholder, income of deviceholder, and highest education level completed by deviceholder from step 815 may be combined, respectfully, in the computerized table at step 825.

At step 830 the computing device is utilized to generate projected hashed recognition ID values for each break associated with each microsegment demographic attribute, based upon countrywide distribution data, payment instrument holder distribution data, and distribution data for subscribing merchant and peer groups. In an embodiment, the projected hashed recognition ID values for each break are associated with the number of subscribing merchant and/or peer group customers associated with the break and microsegment demographic attribute, and are calculated using a formula as follows:

$$( \begin{matrix}Subscribing Merchant or Competing Peer \\ Merchant Distribution for Break and \\ Individual Demographic Attribute\end{matrix} ) = ( \begin{matrix}Measured Number of Identified \\ Hashed Proxy IDs for Break and \\ Microsegment Demographic Attribute\end{matrix} ) * ( \begin{matrix}Number of Individual at Break \\ for Individual Demographic \\ Attribute According to Census Data\end{matrix} ) / ( \begin{matrix}Number of Individuals at Break \\ for Individual Demographic Attribute \\ According to Private Universe Data\end{matrix} ) \qquad ( Equation 1 )$$

After step 830, execution proceeds to the END.

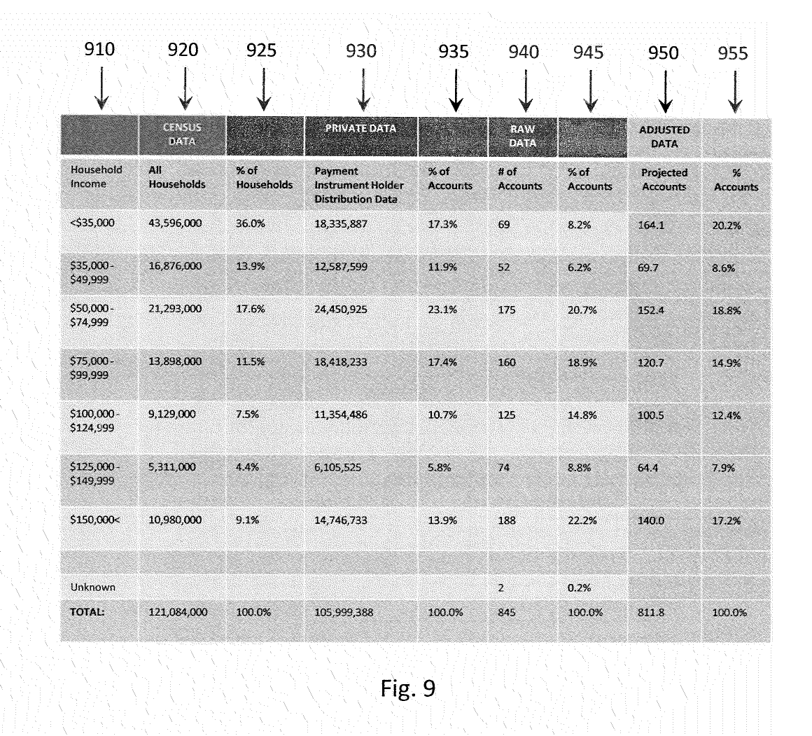

FIG. 9 illustrates the results of the application of the process discussed above in connection with FIG. 8. At column 910 is the initial column headings introducing for the demographic attribute “household income” via a number of breaks (specifically, <$35,000; $35,000-$49,999; $50,000-$74,999; $75,000-$99,999; $100,000-$124,999; $125,000-$149,999; $150,000>) Columns 920 and 925 include U.S. census data that is publicly available. At columns 920 United States census data regarding the number of households in the United States associated with each income “break” are provided. At column 925 percentages of households associated with each break are provided. Columns 930 and 935 include private environment information. At column 930 payment instrument holder distribution data are provided regarding the number of payment instrument holders associated with each income break. Such data may be provided, for example, by a payment instrument issuing institution, an acquirer, a credit agency, or by any other financial-related organization. At column 935 percentages of accountholders associated with each break are provided. At column 940 the measured “raw data” is provided regarding the actual number of accounts. In an embodiment, as is provided in column 940, the “raw data,” measured as the number of identified hashed recognition IDs measured for each break and the demographic attribute is provided, as well as the associated percentages (column 945). At column 950, adjusted data is provided, specifically the projected number of accounts for each break in household income, and associated percentages (column 955) after application of adjustment factors. In an embodiment, Equation 1 (as provided above) is used in connection with data from columns 920, 930, and 940 to calculate the data in column 950.

As would be appreciated by one of skill in the art, the present disclosure will comply with all relevant state, federal, and international laws regarding data privacy.

1. A method of providing competitive data to a subscribing merchant regarding customers of the subscribing merchant and competing peer merchants, said method comprising:
loading by a computing device at least one previously generated microsegment hold table into a database without personally identifiable information;
identifying by the computing device hashed recognition IDs associated with completed payment transactions completed at the subscribing merchant or the competing peer merchants over a timeframe;
merging the at least one previously generated microsegment hold table and identified hashed recognition IDs to generate a microsegment summary file;
transferring the microsegment summary file to a limited-access computing environment;
merging the microsegment summary file and a microsegment definition file to create a summary file indicating a number of identified recognition IDs associated with various statistics; and
utilizing the computing device to summarize a plurality of statistics according to microsegment demographic attributes and breaks to generate summarized demographics.

2. The method of claim 1, wherein the timeframe is selectively one of one year, six months, one month, two weeks, one week, five days, three days, and one day.

3. The method of claim 1, wherein the step of summarizing the plurality of statistics according to microsegment demographic attributes and breaks to generate summarized demographics further comprises adjusting the summarized demographics via application of adjustment factors.

4. The method of claim 1, wherein after the computing device summarizes the plurality of statistics according to microsegment demographic attributes and breaks to generate summarized demographics, the summarized demographics are transferred to a viewing environment for access by the subscribing merchant.

5. The method of claim 1, wherein the summarized demographics are made available to the subscribing merchant to view at least one demographic report.

6. The method of claim 1 wherein the limited-access computing environment is maintained by a financial transaction processing agency.

7. The method of claim 1, wherein the at least one previously generated microsegment hold table is generated by a method comprising:
utilizing the computing device to access a demographic file containing demographic attributes regarding a plurality of individuals;
generating by the computing device a recognition ID for each individual whose demographic attributes are reported in the demographic file and inserting the generated recognition IDs into the demographic file;
transferring the demographic file containing the demographic attributes and recognition IDs to the limited-access computing environment;
generating microsegments by summarizing demographic attributes contained in the demographic file according to a set of demographic attributes;
assigning a unique microsegment sequence number to each microsegment to generate a microsegment definition file;
merging the microsegment definition file and the demographic file to generate a crossreference file showing the microsegment sequence numbers referencing each recognition ID;
transferring the crossreference file to an external database computing environment;
replacing each recognition ID with a generated hashed recognition ID generated by the computing device utilizing a hash function to generate at least one microsegment hold table; and
transferring the at least one microsegment hold table to the database without personally identifiable information.

8. The method of claim 7, wherein the demographic file is located in the external database.

9. The method of claim 7, wherein the set of demographic attributes used for generating microsegments includes at least two of the following: zip code of deviceholder, age of deviceholder, income of deviceholder, and highest educational level completed by deviceholder.

10. The method of claim 7, wherein the demographic file contains at least some of the data points regarding the plurality of individuals including at least one of the following: name of deviceholder, deviceholder identification, age of deviceholder, zip code of deviceholder, income of deviceholder, and highest educational level completed by deviceholder.

11. The method of claim 7, wherein the set of demographic attributes used for generating microsegments includes zip code of deviceholder, age of deviceholder, income of deviceholder, and highest educational level completed by deviceholder.

12. The method of claim 7, further comprising after generating the microsegments, determining whether any of the microsegments contain less than a minimum value of demographic attributes.

13. The method of claim 12, wherein if any of the microsegments contain less than a minimum value of demographic attributes performing a remediative actions.

14. The method of claim 13, wherein the minimum value of demographic attributes is in the range of 2 to 20.

15. The method of claim 13, wherein the remediative action is dropping the microsegment that contains fewer than the minimum value of demographic attributes.

16. The method of claim 13, wherein the remediative action is joining the microsegment containing fewer the minimum value with an adjoining microsegment.

17. The method of claim 7 wherein the limited-access computing environment is maintained by the financial transaction processing agency.

18. The method of claim 3, wherein the adjustment factors are applied via a process comprising the steps of:
utilizing countrywide census data to generate countrywide distribution data, according to microsegment demographic attributes and associated breaks;
utilizing private universe of available deviceholder information to generate payment instrument holder distribution data according to microsegment demographic attributes and associated breaks;
load countrywide distribution data and payment instrument holder distribution data into limited-access computing environment;
combine countrywide distribution data and payment instrument holder distribution data with subscribing merchant distribution data and peer group distribution data into a single table according to microsegment demographic attributes and breaks; and
utilizing the computing device to generate projected hashed recognition ID values for each break associated with each microsegment demographic attribute based upon countrywide distribution data, payment instrument holder distribution data, and distribution data for subscribing merchant and peer group.

19. The method of claim 18 wherein the countrywide census data is taken from United States census data.

20. The method of claim 18 wherein the projected hashed proxy ID values for each break are generated according to the following formula:
$$( \begin{matrix}Subscribing Merchant or Competing Peer \\ Merchant Distribution for Break and \\ Individual Demographic Attribute\end{matrix} ) = ( \begin{matrix}Measured Number of Identified \\ Hashed Proxy IDs for Break and \\ Microsegment Demographic Attribute\end{matrix} ) * ( \begin{matrix}Number of Individual at Break \\ for Individual Demographic \\ Attribute According to Census Data\end{matrix} ) / ( \begin{matrix}Number of Individuals at Break \\ for Individual Demographic Attribute \\ According to Private Universe Data\end{matrix} )$$

21. A method of providing competitive data regarding customers of a subscribing merchant and a set of competing peer merchants, said method comprising:
identifying by a computing device goods and/or services sold by the subscribing merchant and identifying the set of competing peer merchants selling similar goods and/or services in a geographic region;
receiving by the computing device a plurality of completed payment transactions completed at the set of competing peer merchants and subscribing merchant associated with a plurality of customers of the set of competing peer merchants and subscribing merchant;
utilizing the computing device to flag payment transactions completed over a timeframe at the set of competing peer merchants and subscribing merchant;
extracting a plurality of deviceholder identifications associated with a plurality of payment instruments utilized to complete each flagged payment transaction;
transferring the extracted plurality of deviceholder identifications to an anonymized processing environment;
receiving hashed deviceholder identifications from the anonymized processing environment and inserting into a data file;
accessing a customer information database containing a cross-reference file to determine a plurality of demographic attributes associated with the hashed deviceholder identifications;
aggregating the demographic attributes associated with the individuals holding each anonymized deviceholder identification to generate anonymous statistical data and inserting into the data file;
adjusting anonymous statistical data to become representative of population demographics; and
providing adjusted anonymous statistical data to subscribing merchant.

22. The method of claim 21, wherein the computing device identifies the set of competing peer merchants in the geographic region by defining the geographic region by a local zip code where the subscribing merchant is located.

23. The method of claim 21 wherein said adjusted anonymous statistical data is provided to said subscribing merchant in the form of, selectively, a graph, a report, and a chart.

24. The method of claim 21 wherein said timeframe is selectively one of one year, six months, one month, two weeks, one week, five days, three days, and one day.

25. The method of claim 21 wherein the population demographics used in adjusting anonymous statistical data are generated from selectively one of the following: town demographics, county demographics, state demographics, and country demographics.
